(19) United States
(12) Patent Application Publication
(10) Pub. No.: US 2026/0061986 A1
(43) Pub. Date: Mar. 5, 2026

(54) METHODS AND SYSTEM FOR VEHICLE TOW-HAUL MODE

(71) Applicant: Ford Global Technologies, LLC, Dearborn, MI (US)

(72) Inventors: Jason Meyer, Canton, MI (US); Judhajit Roy, Royal Oak, MI (US); Jonathan Barker, Detroit, MI (US); Naginder Gogna, Northville, MI (US); Sean Santarossa, Amherstburg (CA); Chee Haw Chan, Woodhaven, MI (US); Ming Cheng, Northville, MI (US); Aakash Puntambekar, Canton, MI (US); William Cary Cole, Wixom, MI (US)

(21) Appl. No.: 18/817,593

(22) Filed: Aug. 28, 2024

(51) Int. Cl. B60W 20/13; B60W 10/06; B60W 10/08; B60W 10/26

(52) U.S. Cl. CPC B60W 20/13; B60W 10/06; B60W 10/08; B60W 10/26; B60W 2510/244; B60W 2520/10; B60W 2530/10; B60W 2552/25; B60W 2710/06; B60W 2710/08; B60W 2710/244

(57) ABSTRACT

A method for operating a hybrid vehicle that operates in charge depletion and charge sustaining modes is described. In one example, a battery charge reserve amount is adjusted according to an altitude of a portion of a road that the hybrid vehicle may travel upon. The portion of the road is based on a radial distance from the hybrid vehicle's present geographical position.

### FIELD

The present description relates to methods and a system for operating a hybrid vehicle. The hybrid vehicle may be subject to operating at higher loads.

### BACKGROUND

A hybrid vehicle may augment propulsive effort provided via an internal combustion engine with propulsive effort that is provided via an electric machine. This may be especially true if the hybrid vehicle is operating at higher loads. For example, if the hybrid vehicle is operating at high loads (e.g., hauling a low or towing a trailer), the internal combustion engine may be assisted by the electric machine to meet higher driver demands. However, for the electric machine to provide propulsive effort, the vehicle's electric power storage device (e.g., a battery) has to have sufficient stored charge. If the hybrid vehicle is augmenting power that is provided by the internal combustion engine with power that is provided via the electric machine and charge stored in the vehicle's power storage device falls to less than a threshold level, the hybrid vehicle may have to rely solely on internal combustion engine power until the vehicle's electric power storage device may be recharged. Therefore, it may be desirable to provide a way of ensuring that electric power is available

It may be understood that the background above is provided to give some context to the systems and methods described in the detailed description. The background is not meant to identify key features of the claimed subject matter, the scope of which is defined uniquely by the claims that follow the detailed description. Furthermore, the claimed subject matter is not constrained to implementations that solve any disadvantages noted in any part of this disclosure.

### BRIEF DESCRIPTION OF THE DRAWINGS

FIG. 1 shows a schematic diagram of an internal combustion engine;

FIGS. 2A and 2B show schematic diagrams of example vehicle drivelines or powertrains;

FIG. 3 shows an example power storage levels for an electric energy storage device when a vehicle is operating in two different modes;

FIG. 4 shows battery state of charge while a vehicle is operating in different modes.

FIGS. 5-8 show graphic representations of data structures and portions of the data structures that may be applied when a vehicle proceeds along a travel route.

FIG. 9 is a flowchart of a method for operating a hybrid vehicle.

### DETAILED DESCRIPTION

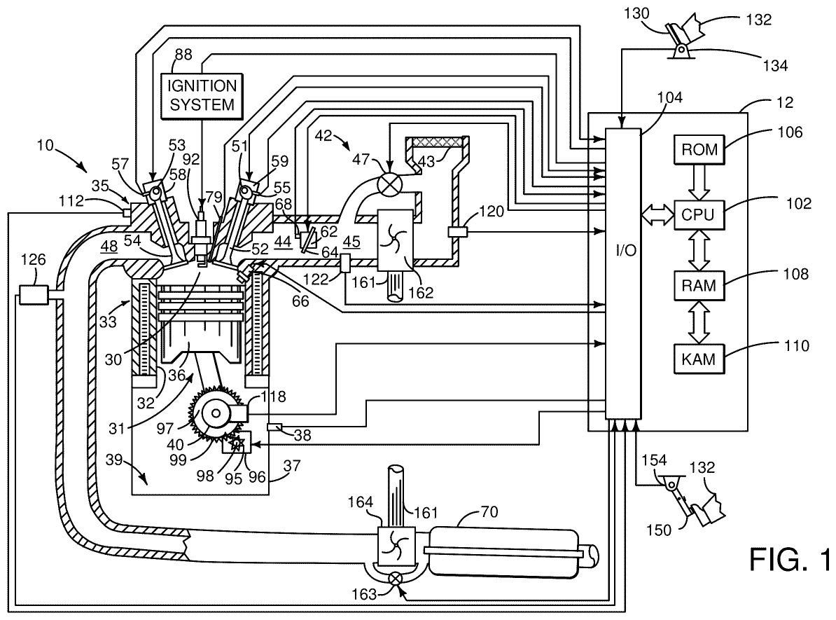

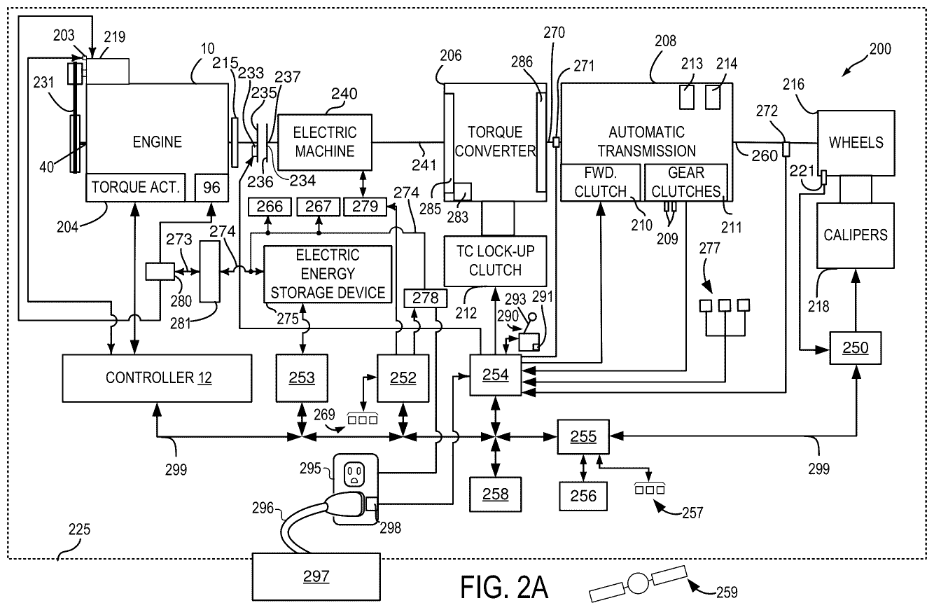

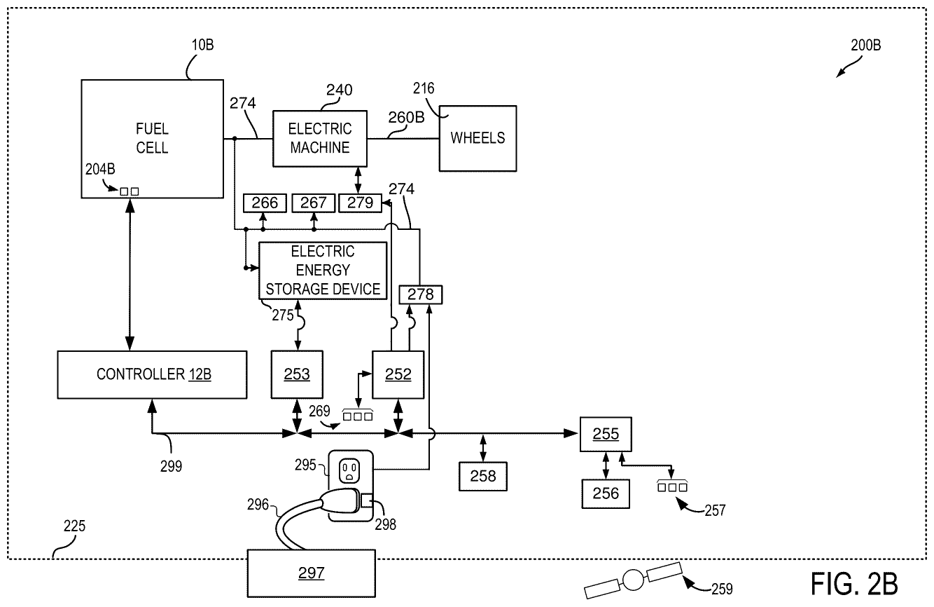

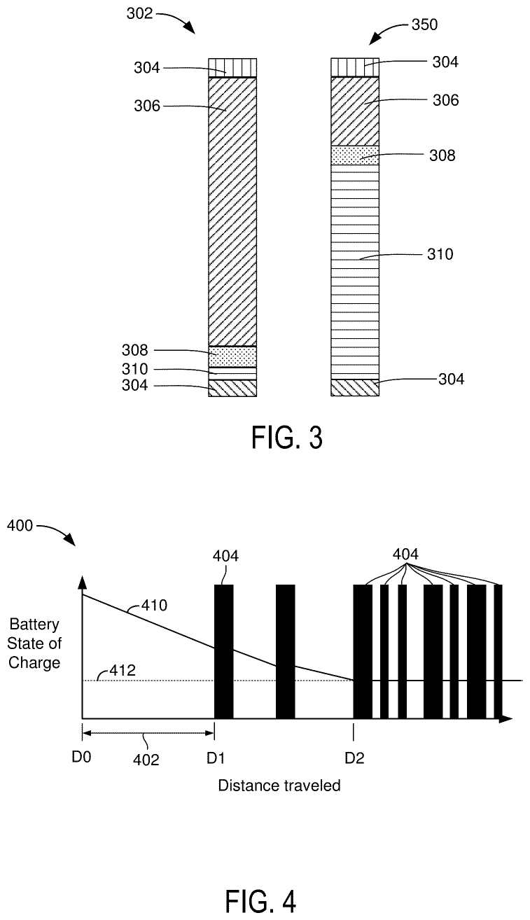

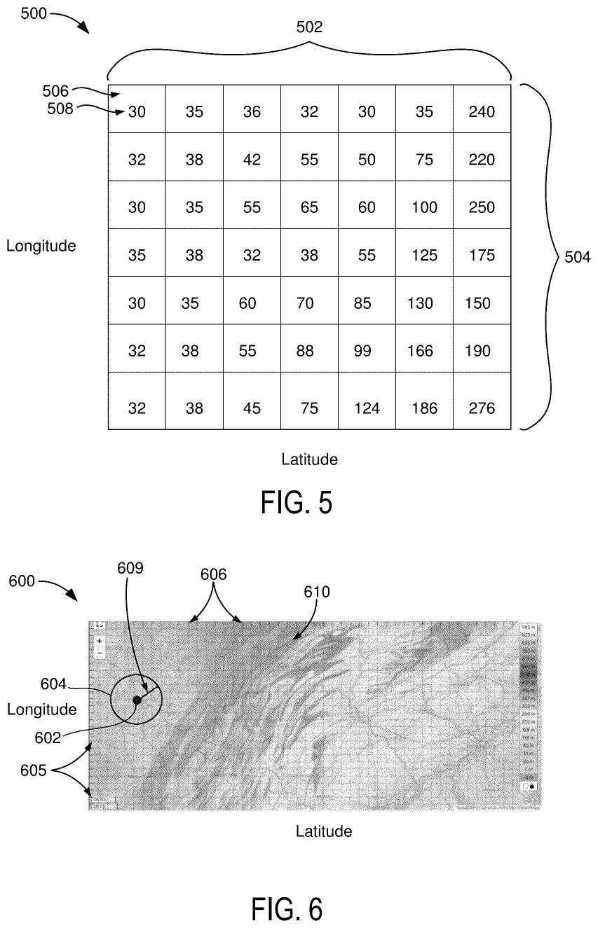

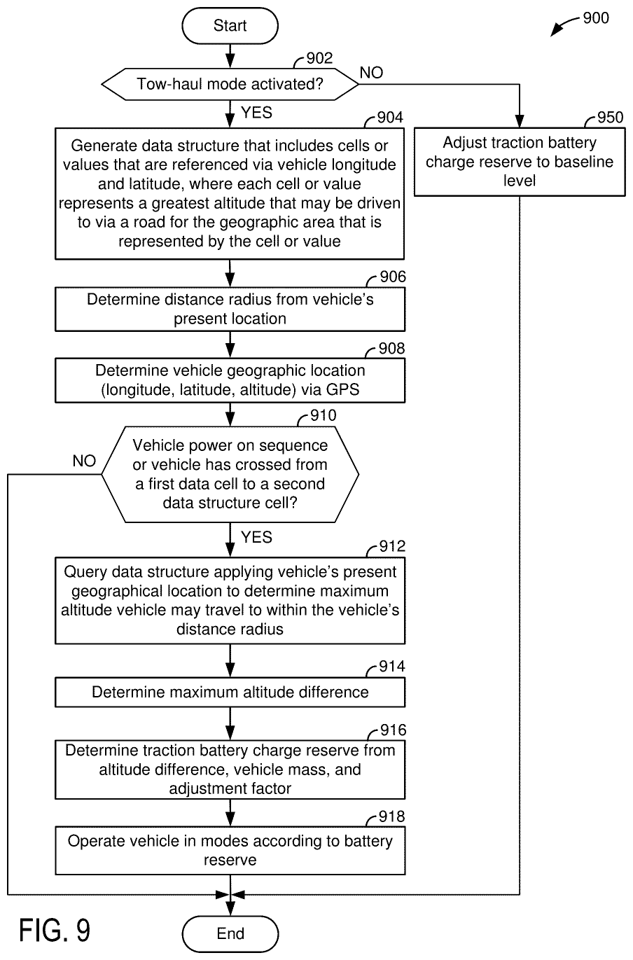

The present description is related to adapting an electric energy storage device electric power reserve level so that a hybrid vehicle may have capacity to augment internal combustion engine power while the hybrid vehicle is traversing road grades within a predetermined radial distance from a present position of the hybrid vehicle. An internal combustion engine is shown in FIG. 1. The internal combustion engine of FIG. 1 is included in a driveline of a hybrid vehicle as shown in FIG. 2A. An alternative driveline or powertrain is shown in FIG. 2B. Example charge storage levels for an electric energy storage device are shown in FIG. 3. Battery state of charge levels while operating a vehicle in different modes are shown in FIG. 4. Graphic representations of data structures stored in controller memory are shown in FIGS. 5-8. Finally, a flowchart of method for operating a vehicle is shown in FIG. 9.

A hybrid vehicle may utilize an electric machine to increase vehicle efficiency and extend vehicle driving range. The hybrid vehicle may also haul a load (e.g., construction materials, appliances, etc.) and/or tow a trailer from time to time. To extend the vehicle's driving range, the hybrid vehicle may propel the vehicle solely via the electric machine at least until battery state of charge (SOC) is less than a threshold state of charge. Once the battery reaches the lower SOC, the hybrid vehicle may operate in a charge sustain mode where the vehicle may be propelled via a combination of the battery and an internal combustion engine. However, if the hybrid vehicle operates with this same strategy when the hybrid vehicle is carrying a load and/or towing a trailer, the hybrid vehicle's performance when traversing extended uphill road grades may not meet performance objectives. Therefore, it may be desirable to provide a way of operating a vehicle so that vehicle range may be extended via the vehicle's battery when the vehicle is lightly loaded and so that the vehicle performs well when hauling or towing on extended uphill road grades.

The inventors herein have recognized the above-mentioned issues and have developed a method for operating a hybrid vehicle, comprising: adjusting a vehicle battery charge reserve amount in response to a maximum altitude of a portion of a road within a predetermined distance of the hybrid vehicle, the road having a greatest altitude of a plurality of roads within the predetermined distance of the vehicle; and adjusting engine operation of the hybrid vehicle's internal combustion engine and electric machine in response to the vehicle battery charge reserve amount.

By adjusting a battery charge reserve amount according to a maximum altitude that a hybrid vehicle may drive to within a predetermined distance of the hybrid vehicle, it may be possible to conserve electric power of a traction battery for hauling and towing conditions when the hybrid vehicle is ascending a road having a highest elevation of roads within the predetermined distance of the hybrid vehicle. Consequently, the hybrid vehicle may perform well if the hybrid vehicle's driver chooses to travel on the road having the highest elevation within the predetermined distance of the hybrid vehicle.

The present description may provide several advantages. Specifically, the approach may allow a hybrid vehicle to have enough available power to ascend a grade of a road that reaches a highest elevation of roads that are within a predetermined distance of the hybrid vehicle without the hybrid vehicle's battery running out of charge. Further, the approach allows the hybrid vehicle to have extended driving range when the hybrid vehicle is unloaded and traveling on relatively flat roads. In addition, the approach may be applied to fuel cell vehicles as well as hybrid vehicles that include an internal combustion engine.

The above advantages and other advantages, and features of the present description will be readily apparent from the following Detailed Description when taken alone or in connection with the accompanying drawings.

Referring to FIG. 1, internal combustion engine 10, comprising a plurality of cylinders, one cylinder of which is shown in FIG. 1, is controlled by electronic engine controller 12. Engine 10 is comprised of cylinder head 35 and block 33, which include combustion chamber 30 and cylinder walls 32. Piston 36 is positioned therein and reciprocates via a connection to crankshaft 40. Flywheel 97 and ring gear 99 are coupled to crankshaft 40. Starter 96 (e.g., low voltage (operated with less than 20 volts) electric machine) includes pinion shaft 98 and pinion gear 95. Pinion shaft 98 may selectively advance pinion gear 95 to engage ring gear 99. Starter 96 may be directly mounted to the front of the engine or the rear of the engine. In some examples, starter 96 may selectively supply torque to crankshaft 40 via a chain. In one example, starter 96 is in a base state when not engaged to the engine crankshaft.

Combustion chamber 30 is shown communicating with intake manifold 44 and exhaust manifold 48 via respective intake poppet valve 52 and exhaust poppet valve 54. Each intake and exhaust valve may be operated by an intake cam 51 and an exhaust cam 53. The position of intake cam 51 may be determined by intake cam sensor 55. The position of exhaust cam 53 may be determined by exhaust cam sensor 57. A lift amount and/or a phase or position of intake valve 52 may be adjusted relative to a position of crankshaft 40 via valve adjustment device 59. A lift amount and/or a phase or position of exhaust valve 54 may be adjusted relative to a position of crankshaft 40 via valve adjustment device 58. Valve adjustment devices 58 and 59 may be electro-mechanical devices, hydraulic devices, or mechanical devices.

Engine 10 includes a crankcase 39 that houses crankshaft 40. Oil pan 37 may form a lower boundary of crankcase 39 and engine block 33 and piston 36 may constitute an upper boundary of crankcase 39. Crankcase 39 may include a crankcase ventilation valve (not shown) that may vent gases to combustion chamber 30 via intake manifold 44. A temperature of oil in crankcase 39 may be sensed via temperature sensor 38.

Fuel injector 66 is shown positioned to inject fuel directly into cylinder 31, which is known to those skilled in the art as direct injection. Fuel injector 66 delivers liquid fuel in proportion to the pulse width from controller 12. Fuel is delivered to fuel injector 66 by a fuel system (not shown) including a fuel tank, fuel pump, and fuel rail (not shown). In one example, a high pressure, dual stage, fuel system may be used to generate higher fuel pressures.

In addition, intake manifold 44 is shown communicating with turbocharger compressor 162 and engine air intake 42. In other examples, compressor 162 may be a supercharger compressor. Shaft 161 mechanically couples turbocharger turbine 164 to turbocharger compressor 162. Optional electronic throttle 62 adjusts a position of throttle plate 64 to control air flow from compressor 162 to intake manifold 44. Pressure in boost chamber 45 may be referred to a throttle inlet pressure since the inlet of throttle 62 is within boost chamber 45. The throttle outlet is in intake manifold 44. In some examples, throttle 62 and throttle plate 64 may be positioned between intake valve 52 and intake manifold 44 such that throttle 62 is a port throttle. Compressor recirculation valve 47 may be selectively adjusted to a plurality of positions between fully open and fully closed. Waste gate 163 may be adjusted via controller 12 to allow exhaust gases to selectively bypass turbine 164 to control the speed of compressor 162. Air filter 43 cleans air entering engine air intake 42.

Distributorless ignition system 88 provides an ignition spark to combustion chamber 30 via spark plug 92 in response to controller 12. Universal Exhaust Gas Oxygen (UEGO) sensor 126 is shown coupled to exhaust manifold 48 upstream of catalytic converter 70. Alternatively, a two-state exhaust gas oxygen sensor may be substituted for UEGO sensor 126.

Converter 70 can include multiple catalyst bricks, in one example. In another example, multiple emission control devices, each with multiple bricks, can be used. Converter 70 can be a three-way type catalyst in one example.

Controller 12 is shown in FIG. 1 as a conventional microcomputer including: microprocessor unit 102, input/output ports 104, read-exclusive memory 106 (e.g., non-transitory memory), random access memory 108, keep alive memory 110, and a conventional data bus. Controller 12 is shown receiving various signals from sensors coupled to engine 10, in addition to those signals previously discussed, including: cylinder head temperature from temperature sensor 112 coupled to cylinder head 35; a position sensor 134 coupled to a driver demand pedal 130 for sensing force applied by human foot 132; a position sensor 154 coupled to caliper application pedal 150 for sensing force applied by foot 152, a measurement of engine manifold pressure (MAP) from pressure sensor 122 coupled to intake manifold 44; an engine position sensor 118 sensing a position of crankshaft 40; a measurement of air mass entering the engine from sensor 120; and a measurement of throttle position from sensor 68. Barometric pressure may also be sensed (sensor not shown) for processing by controller 12. In a preferred aspect of the present description, engine position sensor 118 produces a predetermined number of equally spaced pulses each revolution of the crankshaft from which engine speed (RPM) can be determined.

During operation, each cylinder within engine 10 typically undergoes a four stroke cycle: the cycle includes the intake stroke, compression stroke, expansion stroke, and exhaust stroke. During the intake stroke, generally, the exhaust valve 54 closes and intake valve 52 opens. Air is introduced into combustion chamber 30 via intake manifold 44, and piston 36 moves to the bottom of the cylinder so as to increase the volume within combustion chamber 30. The position at which piston 36 is near the bottom of the cylinder and at the end of its stroke (e.g. when combustion chamber 30 is at its largest volume) is typically referred to by those of skill in the art as bottom dead center (BDC).

During the compression stroke, intake valve 52 and exhaust valve 54 are closed. Piston 36 moves toward the cylinder head so as to compress the air within combustion chamber 30. The point at which piston 36 is at the end of its stroke and closest to the cylinder head (e.g. when combustion chamber 30 is at its smallest volume) is typically referred to by those of skill in the art as top dead center (TDC). In a process hereinafter referred to as injection, fuel is introduced into the combustion chamber. In a process hereinafter referred to as ignition, the injected fuel is ignited by known ignition means such as spark plug 92, resulting in combustion.

During the expansion stroke, the expanding gases push piston 36 back to BDC. Crankshaft 40 converts piston movement into a rotational torque of the rotary shaft. Finally, during the exhaust stroke, the exhaust valve 54 opens to release the combusted air-fuel mixture to exhaust manifold 48 and the piston returns to TDC. Note that the above is shown merely as an example, and that intake and exhaust valve opening and/or closing timings may vary, such as to provide positive or negative valve overlap, late intake valve closing, or various other examples.

FIG. 2A is a block diagram of a vehicle 225 including a powertrain or driveline 200. The powertrain of FIG. 2A includes engine 10 shown in FIG. 1. Powertrain 200 is shown including vehicle system controller 255, engine controller 12, electric machine controller 252, transmission controller 254, energy storage device controller 253, and friction caliper controller 250. The controllers may communicate over controller area network (CAN) 299. Each of the controllers may provide information to other controllers such as power output thresholds (e.g., power output of the device or component being controlled not to be exceeded), power input thresholds (e.g., power input of the device or component being controlled not to be exceeded), power output of the device being controlled, sensor and actuator data, diagnostic information (e.g., information regarding a degraded transmission, information regarding a degraded engine, information regarding a degraded electric machine, information regarding degraded friction calipers). Further, the vehicle system controller 255 may provide commands to engine controller 12, electric machine controller 252, transmission controller 254, and caliper controller 250 to achieve driver input requests and other requests that are based on vehicle operating conditions.

For example, in response to a driver releasing a driver demand pedal and vehicle speed, vehicle system controller 255 may request a desired wheel power or a wheel power level to provide a desired rate of vehicle slowing. The requested desired wheel power may be provided by vehicle system controller 255 requesting a first vehicle slowing power from electric machine controller 252 and a second vehicle slowing power from engine controller 12, the first and second powers providing a desired driveline vehicle slowing power at vehicle wheels 216. Vehicle system controller 255 may also request a friction caliper power via caliper controller 250. The vehicle slowing powers may be referred to as negative powers since they slow driveline and wheel rotation. Positive power may maintain or increase driveline and wheel rotation.

Vehicle controller 255 and/or engine controller 12 may also receive input from human/machine interface 256 and traffic conditions (e.g., traffic signal status, distance to objects, etc.) from sensors 257 (e.g., cameras, LIDAR, RADAR, etc.). In one example, human/machine interface 256 may be a touch input display panel. Alternatively, human/machine interface 256 may be a key switch or other known type of human/machine interface. Human/machine interface 256 may receive requests from a user. For example, a user may request an engine stop or start via human/machine interface 256. Further, a user may override inhibiting of motion of wheels 216 when external electric power consumer 297 is coupled to vehicle 255. Additionally, human/machine interface 256 may display status messages and engine data that may be received from controller 255. Vehicle controller 255 and/or engine controller 12 may also receive vehicle geographical information and data from navigation system 258. Navigation system 258 may receive information from global positioning satellites 259.

In other examples, the partitioning of controlling powertrain devices may be partitioned differently than is shown in FIG. 2A. For example, a single controller may take the place of vehicle system controller 255, engine controller 12, electric machine controller 252, transmission controller 254, and caliper controller 250. Alternatively, the vehicle system controller 255 and the engine controller 12 may be a single unit while the electric machine controller 252, the transmission controller 254, and the caliper controller 250 are standalone controllers.

In this example, powertrain 200 may be powered by engine 10 and electric machine 240. In other examples, engine 10 may be omitted. Engine 10 may be started with an engine starting system shown in FIG. 1, via integrated starter/generator BISG 219, or via electric machine. A temperature of BISG windings may be determined via BISG winding temperature sensor 203. Electric machine 240 (e.g., high voltage (operated with greater than 30 volts) electrical machine) may also be referred to as a motor and/or a generator. Further, power of engine 10 may be adjusted via torque actuator 204, such as a fuel injector, throttle, etc.

BISG 219 is mechanically coupled to engine 10 via coupling loop 231 and BISG 219 may be referred to as an electric machine, motor, or generator. BISG 219 may be coupled to crankshaft 40 or a camshaft (e.g., 51 or 53 of FIG. 1). BISG 219 may operate as a motor when supplied with electrical power via low voltage bus 273 and/or low voltage battery 280. BISG 219 may operate as a generator supplying electrical power to low voltage battery 280 and/or low voltage bus 273. Power converter 281 (e.g., a bi-directional DC/DC converter) may transfer electrical energy from a high voltage bus 274 to a low voltage bus 273 or vice-versa. Low voltage battery 280 is electrically directly coupled to low voltage buss 273. Low voltage bus 273 may be comprised of one or more electrical conductors. Electric energy storage device 275 (e.g., a high voltage battery or traction battery) is electrically coupled to high voltage bus 274. Positive temperature coefficient (PTC) electric heater 266 and electrically driven climate control system (e.g., a heat pump) 267 are also electrically coupled to high voltage bus 274 and may receive electric power via high voltage bus 274. Low voltage battery 280 may selectively supply electrical energy to starter motor 96 and/or BISG 219.

An engine output power may be transmitted to a first or upstream side of powertrain disconnect clutch 235 through dual mass flywheel 215. Disconnect clutch 236 is hydraulically actuated and hydraulic pressure within driveline disconnect clutch 236 (driveline disconnect clutch pressure) may be adjusted via electrically operated valve 233. The downstream or second side 234 of disconnect clutch 236 is shown mechanically coupled to electric machine input shaft 237.

Electric machine 240 may be operated to provide power to powertrain 200 or to convert powertrain power into electrical energy to be stored in electric energy storage device 275 in a regeneration mode (e.g., regenerative vehicle slowing where electric machine 240 reduces the vehicle speed via converting the vehicle's kinetic energy into electric energy). Electric machine 240 is in electrical communication with energy storage device 275 via inverter 279. Inverter 279 may convert direct current (DC) electric power from electric energy storage device 275 into alternating current (AC) electric power for operating electric machine 240. Alternatively, inverter 279 may convert AC power from electric machine 240 into DC power for storing in electric energy storage device 275. Inverter 279 may be controlled via electric machine controller 252 and electric machine controller 252 may receive sensor signals and/or data via sensors 269 (e.g., electric machine temperature sensors, electric machine current sensors, etc.). Electric machine 240 has a higher output power capacity than starter 96 shown in FIG. 1 or BISG 219. Further, electric machine 240 directly drives powertrain 200 or is directly driven by powertrain 200. There are no loops, gears, or chains to couple electric machine 240 to powertrain 200. Rather, electric machine 240 rotates at the same rate as powertrain 200. Electrical energy storage device 275 (e.g., high voltage battery or power source) may be a battery, capacitor, or inductor. The downstream side of electric machine 240 is mechanically coupled to the impeller 285 of torque converter 206 via shaft 241. The upstream side of the electric machine 240 is mechanically coupled to the disconnect clutch 236. Electric machine 240 may provide a positive power or a negative power to powertrain 200 via operating as a motor or generator as instructed by electric machine controller 252.

Power converter 278 (e.g., an inverter) is shown electrically coupled to electric energy storage device 275 via high voltage bus 274 and electrical output receptacle 295. Power converter 278 may convert DC power to AC power for operating external electric power consumer 297 (e.g., hand tools, entertainment systems, lighting, pumps, etc.). Power converter 278 may convert electric power from low voltage battery 280, electric power from electric energy storage device 275, or electric power from electric machine 240 or BISG 219 into electric power that is delivered to electrical output receptacle 295. External electric power consumer 297 may be located off-board vehicle 225 or they may be added to vehicle 225. External power consumer 297 may be electrically coupled to electrical output receptacle 295 via power cord 296. External electric power consumer sensor 298 may detect the presence or absence of external power consumer 297. Electric power consumer sensor 298 may physically sense the presence of cord 296 via a switch input, or alternatively, sensor 298 may be a current sensor and detect electric current flow out of electrical output receptacle 295 to determine the presence or absence of external power consumer 297.

Torque converter 206 includes a turbine 286 to output power to input shaft 270. Input shaft 270 mechanically couples torque converter 206 to automatic transmission 208. Torque converter 206 also includes a torque converter bypass lock-up clutch 212 (TCC). Power is directly transferred from impeller 285 to turbine 286 when TCC 212 is locked. TCC 212 is electrically operated by controller 254. Alternatively, TCC may be hydraulically locked. In one example, the torque converter 206 may be referred to as a component of the transmission.

When torque converter lock-up clutch 212 is fully disengaged, torque converter 206 transmits engine power to automatic transmission 208 via fluid transfer between the torque converter turbine 286 and torque converter impeller 285, thereby enabling torque multiplication. In contrast, when torque converter lock-up clutch 212 is fully engaged, the engine output power is directly transferred via the torque converter clutch to an input shaft 270 of transmission 208. Alternatively, the torque converter lock-up clutch 212 may be partially engaged, thereby enabling the amount of power that is directly delivered to the transmission to be adjusted. The transmission controller 254 may be configured to adjust the amount of power transmitted by torque converter 212 by adjusting the torque converter lock-up clutch in response to various engine operating conditions, or based on a driver-based engine operation request.

Torque converter 206 also includes pump 283 that pressurizes fluid to operate disconnect clutch 236, forward clutch 210, and gear clutches 211. Pump 283 is driven via impeller 285, which rotates at a same speed as electric machine 240.

Automatic transmission 208 includes gear clutches 211 and forward clutch 210 for selectively engaging and disengaging forward gears 213 (e.g., gears 1-10) and reverse gear 214. Automatic transmission 208 is a fixed ratio transmission. Alternatively, transmission 208 may be a continuously variable transmission that has a capability of simulating a fixed gear ratio transmission and fixed gear ratios. The gear clutches 211 and the forward clutch 210 may be selectively engaged to change a ratio of an actual total number of turns of input shaft 270 to an actual total number of turns of wheels 216. Gear clutches 211 may be engaged or disengaged via adjusting fluid supplied to the clutches via shift control solenoid valves 209. Power output from the automatic transmission 208 may also be relayed to wheels 216 to propel the vehicle via output shaft 260. Specifically, automatic transmission 208 may transfer an input driving power at the input shaft 270 responsive to a vehicle traveling condition before transmitting an output driving power to the wheels 216. Transmission controller 254 selectively activates or engages TCC 212, gear clutches 211, and forward clutch 210. Transmission controller also selectively deactivates or disengages TCC 212, gear clutches 211, and forward clutch 210.

Further, a frictional force may be applied to wheels 216 by engaging friction calipers 218. In one example, friction calipers 218 may be engaged in response to a human driver pressing their foot on a foot caliper pedal (not shown) and/or in response to instructions within caliper controller 250. Further, caliper controller 250 may apply friction calipers 218 in response to information and/or requests made by vehicle system controller 255. In the same way, a frictional force may be reduced to wheels 216 by disengaging friction calipers 218 in response to the human driver releasing their foot from a caliper pedal, caliper controller instructions, and/or vehicle system controller instructions and/or information.

In response to a request to move vehicle 225, vehicle system controller may obtain a driver demand power or torque, or a power or torque request from a driver demand pedal or other device. Vehicle system controller 255 then allocates a fraction of the requested driver demand power or torque to the engine to generate and the remaining fraction of driver demand power or torque for the electric machine 240 or BISG to generate. Vehicle system controller 255 requests the engine power from engine controller 12 and the electric machine power from electric machine controller 252. If the electric machine power plus the engine power is less than a transmission input power threshold (e.g., a power input threshold value not to be exceeded), the power is delivered to torque converter 206 which then relays at least a fraction of the requested power to transmission input shaft 270. Transmission controller 254 selectively locks torque converter clutch 212 and engages gears via gear clutches 211 in response to shift schedules and TCC lockup schedules that may be based on input shaft power and vehicle speed. In some conditions when it may be desired to charge electric energy storage device 275, a charging power (e.g., a negative electric machine power) may be requested while a non-zero driver demand power is present. Vehicle system controller 255 may request increased engine power to overcome the charging power to meet the driver demand power.

Accordingly, power control of the various powertrain components may be supervised by vehicle system controller 255 with local power control for the engine 10, transmission 208, electric machine 240, and friction calipers 218 provided via engine controller 12, electric machine controller 252, transmission controller 254, and caliper controller 250.

As one example, an engine power output may be controlled by adjusting a combination of spark timing, fuel pulse width, fuel pulse timing, and/or air charge, by controlling throttle opening and/or valve timing, valve lift and boost for turbo-or super-charged engines. In the case of a diesel engine, controller 12 may control the engine power output by controlling a combination of fuel pulse width, fuel pulse timing, and air charge. Engine speed reducing power or negative engine power may be provided by rotating the engine with the engine generating power that is insufficient to rotate the engine. Thus, the engine may generate a slowing power via operating at a low power while combusting fuel, with one or more cylinders deactivated (e.g., not combusting fuel), or with all cylinders deactivated and while rotating the engine. The amount of engine slowing power may be adjusted via adjusting engine valve timing. Engine valve timing may be adjusted to increase or decrease engine compression work. Further, engine valve timing may be adjusted to increase or decrease engine expansion work. In all cases, engine control may be performed on a cylinder-by-cylinder basis to control the engine power output.

Electric machine controller 252 may control power output and electrical energy production from electric machine 240 by adjusting current flowing to and from field and/or armature windings of electric machine 240 as is known in the art.

Transmission controller 254 receives transmission input shaft position via position sensor 271. Transmission controller 254 may convert transmission input shaft position into input shaft speed via differentiating a signal from position sensor 271 or counting a number of known angular distance pulses over a predetermined time interval. Transmission controller 254 may receive transmission output shaft torque from torque sensor 272. Alternatively, sensor 272 may be a position sensor or torque and position sensors. If sensor 272 is a position sensor, controller 254 may count shaft position pulses over a predetermined time interval to determine transmission output shaft velocity. Transmission controller 254, engine controller 12, and vehicle system controller 255, may also receive addition transmission information from sensors 277, which may include but are not constrained to pump output line pressure sensors, transmission hydraulic pressure sensors (e.g., gear clutch fluid pressure sensors), ISG temperature sensors, and BISG temperatures, gear shift lever sensors, ambient temperature sensors, trailer present sensor, and vehicle suspension sensors. Transmission controller 254 may also receive requested gear input from gear shift selector 290 (e.g., a human/machine interface device). Gear shift selector 290 may include positions for gears 1-X (where X is an upper gear number), D (drive), neutral (N), and P (park). Shift selector 290 shift lever 293 may be prevented from moving via a solenoid actuator 291 that selectively prevents shift lever 293 from moving from park or neutral into reverse or a forward gear position (e.g., drive).

Caliper controller 250 receives wheel speed information via wheel speed sensor 221 and vehicle slowing requests from vehicle system controller 255. Caliper controller 250 may also receive vehicle slowing pedal position information from caliper application pedal sensor 154 shown in FIG. 1 directly or over CAN 299. Caliper controller 250 may provide caliper application to the wheels responsive to a wheel power command from vehicle system controller 255. Caliper controller 250 may also provide anti-lock and vehicle stability caliper activation to increase vehicle stability. As such, caliper controller 250 may provide a wheel power threshold (e.g., a threshold negative wheel power not to be exceeded) to the vehicle system controller 255 so that negative ISG power does not cause the wheel power threshold to be exceeded. For example, if caliper controller 250 issues a negative wheel torque threshold of 50 N-m, electric machine power is adjusted to provide less than 50 N-m (e.g., 49 N-m) of negative torque at the wheels, including compensating for transmission gearing.

Referring now to FIG. 2B, an alternative powertrain 200B for vehicle 225 is shown. Some of the elements that are shown in FIG. 2B are the same elements that are shown in FIG. 2A. Elements shown in FIG. 2B that are numbered the same as elements that are shown in FIG. 2A are equivalent elements. Therefore, the description of these elements is omitted for the sake of brevity.

In this powertrain, fuel cell 10B generates electric current that may be supplied to electric machine and/or electric energy storage device 275 via high voltage bus 274. Electric machine 240 converts electric power into mechanical power to rotate wheels 216. Controller 12B may adjust the amount of current that is output of fuel cell 10B via adjusting one or more power actuators (e.g., valves that control flow of hydrogen and oxygen to fuel cell 10B) 204B.

The system of FIGS. 1 and 2 provides for a vehicle, comprising: a chemically fueled power source (e.g., an internal combustion engine or fuel cell); an electric machine; a traction battery; a human/machine interface; and a controller including executable instructions stored in non-transitory memory that cause the controller to reference a data structure containing altitude values according to a present geographical location of the vehicle and a predetermined distance, adjust a reserve amount of the traction battery in response to an altitude, and operate the chemically fueled power source and the electric machine according to the reserve amount. In a first example, the vehicle includes where the data structure (e.g., an array of memory storage locations (bytes, words, etc.)) is segmented into a plurality of cells, and where the cells are referenced according to longitude coordinated and latitude coordinates. In a second example that may include the first example, the vehicle further comprises a vehicle navigation system that communicates the present geographical location to the controller. In a third example that includes one or both of the first and second examples, the vehicle includes where the reserve amount of power is an amount of power that may be supplied to the electric machine when the chemically fueled power source is operating within a predetermined amount of maximum power of the chemically fueled power source at a present speed of the chemically fueled power source. In a fourth example that includes one or more of the first through third examples, the vehicle further comprises additional executable instructions stored in non-transitory memory that cause the controller to retrieve the altitude from the data structure. In a fifth example that includes one or more of the first through fourth examples, the vehicle includes where operating the chemically fueled power source and the electric machine according to the reserve amount includes activating the chemically fueled power source to maintain the reserve amount. In a sixth example that includes one or more of the first through fifth examples, the vehicle includes where the reserve amount is adjusted in further response to a mass of the vehicle. In a seventh example that includes one or more of the first through sixth examples, the vehicle includes where the reserve amount is adjusted in further response to a distance to a zone boundary.

The system of FIGS. 1-2B includes a vehicle, comprising: a chemically fueled power source; an electric machine; a traction battery; a human/machine interface; and a controller including executable instructions stored in non-transitory memory that cause the controller to reference a data structure containing altitude values according to a present geographical location of the vehicle and a predetermined distance, adjust a reserve amount of the traction battery in response to an altitude, and operate the chemically fueled power source and the electric machine according to the reserve amount. In a first example, the vehicle includes where the data structure is segmented into a plurality of cells, and where the cells are referenced according to longitude coordinates and latitude coordinates. In a second example that may include the first example, the vehicle further comprises a vehicle navigation system that communicates the present geographical location to the controller. In a third example that may include one or both of the first and second examples, the vehicle includes where the reserve amount of power is an amount of power that may be supplied to the electric machine when the chemically fueled power source is operating within a predetermined amount of maximum power of the chemically fueled power source at a present speed of the chemically fueled power source. In a fourth example that may include one or more of the first through third examples, the vehicle further comprises additional executable instructions stored in non-transitory memory that cause the controller to retrieve the altitude from the data structure. In a fifth example that may include one or more of the first through fourth examples, the vehicle includes where operating the chemically fueled power source and the electric machine according to the reserve amount includes activating the chemically fueled power source to maintain the reserve amount. In a sixth example that may include one or more of the first through fifth examples, the vehicle includes where the reserve amount is adjusted in further response to a mass of the vehicle. In a seventh example that may include one or more of the first through sixth examples, the vehicle includes where the reserve amount is adjusted in further response to a distance to a zone boundary.

Referring now to FIG. 3, shows example state of charge allocations for two different operating modes. Bar 302 represents state of charge (SOC) allocation percentages for a baseline operating mode and bar 350 represents SOC allocation percentages for a tow-haul mode (e.g., a mode where the vehicle is towing a trailer or hauling a load). The total length of each bar represents 100 percent SOC for the traction battery.

The baseline operating mode bar 302 includes a charge constrained allocation as shown at 304, a charge depletion allocation or amount 306, a charge sustain allocation or amount 308, a charge energy reserve allocation or amount 310, and a discharge constrained allocation or amount 312. In this mode, a charge constrained allocation 304 may be in the range of 10-15% of total SOC, the charge depletion allocation or amount 306 may be in a range of 40-70% of total SOC, the charge sustain allocation or amount 308 may be in a range of 5-15% of total SOC, the charge energy reserve allocation or amount 310 may be in a range of 5-15% of total SOC, and a discharge constrained allocation or amount 312 may be in a range of 10-15% of total SOC.

The tow-haul operating mode bar 350 also includes a charge constrained allocation as shown at 304, a charge depletion allocation or amount 306, a charge sustain allocation or amount 308, a charge energy reserve allocation or amount 310, and a discharge constrained allocation or amount 312. In this mode, a charge constrained allocation 304 may be in the range of 10-15% of total SOC, the charge depletion allocation or amount 306 may be in a range of 10-15% of total SOC, the charge sustain allocation or amount 308 may be in a range of 5-10% of total SOC, the charge energy reserve allocation or amount 310 may be in a range of 45-65% of total SOC, and a discharge constrained allocation or amount 312 may be in a range of 10-15% of total SOC.

The battery reserve amount determined at step 914 of the method of FIG. 9 indicates the charge energy reserve allocation amount. Additionally, the vehicle traction battery charge sustain amount may be adjusted in response to attributes of a road that is within a threshold radial distance from the vehicle. For example, the traction battery charge sustain amount and the traction battery charge depletion amount may be adjusted as a function of an altitude increase from the vehicle's present geographical condition to a maximum altitude of a road within the threshold radial distance from the vehicle, where the road is a road that reaches a greatest altitude of roads within the threshold radial distance from the vehicle.

Referring now to FIG. 4, an example battery charge depletion sequence is shown. Plot 400 includes a vertical axis and a horizontal axis. The vertical axis represents battery state of charge and battery state of charge increase in the direction of the vertical axis arrow. The horizontal axis represents distance traveled and the distance traveled increases from the vertical axis in the direction of the horizontal axis arrow.

Line 410 represents battery state of charge. Horizontal line 412 represents a charge sustain level. Black bars 404 represent times when the vehicle's chemically fueled power source (e.g., an internal combustion engine or a fuel cell) is activated (e.g., rotating and combusting fuel or converting hydrogen and oxygen into electric power).

At distance D0 the battery SOC is at a high level and the chemically fueled power source is not activated. The battery is supplying charge to propel the vehicle (not shown) and the vehicle is operating in all electric mode. The vehicle is in a charge depletion mode where the battery SOC may be reduced to propel the vehicle.

At distance D1, the vehicle remains in charge depletion mode, but the chemically fueled power source is activated for a short time to charge the traction battery. The traction battery charge is not reduced at this time, but in other examples it may be reduced while the chemically fueled power source is activated. The distance between D1 and D2 represents the distance that the vehicle travels in charge depletion mode.

At distance D2, the vehicle enters a charge sustain mode where charge within the traction battery is maintained. The traction battery charge may be maintained so that degradation of the traction battery may be reduced.

Referring now to FIG. 5, a representation of a data structure 500 (e.g., an array of memory locations in controller memory). The horizontal cells 502 represent data storage locations within the data structure. Vertical cells 504 also represent data storage locations within the data structure. Each cell as indicated at 506 includes a value 508 that represents an altitude level relative to sea level. The vertical cells 504 may be referenced via longitudinal geographical coordinates and horizontal cells 502 may be referenced via latitudinal geographical coordinates. The distance between vertical cells 504 and the distance between horizontal cells 502 may be adjusted according to the size of the geographical area that is represented by data structure 500, the size of the data structure, and desired resolution of data structure 500. In one example, there may be two arc minutes between vertical cells and two arc minutes between horizontal cells.

Each cell 506 holds data (e.g., a value, such as a real number) for a specific geographic area of land that is defined by two longitudinal geographic coordinates and two latitudinal geographic coordinates. Data structure 500 may be referenced by the two longitudinal geographic coordinates and two latitudinal geographic coordinates and the data structure returns the value that is held in data structure 500 at cell that corresponds to the two longitudinal geographic coordinates and two latitudinal geographic coordinates. For example, for the two longitudinal geographic coordinates and two latitudinal geographic coordinates that represent row one, column one, for data structure 500, a value of 30 is returned.

The value (e.g., as shown at 508) of each cell included in data structure 500 represents an elevation or altitude relative to sea level of a highest portion selected from all roads that may be traveled and that lie within the geographical area represented by the data structure cell that is being referenced. For example, each road that may be traveled by a vehicle within a geographical area that is represented by two longitudinal geographic coordinates and two latitudinal geographic coordinates may reach a maximum altitude, from this group of maximum altitudes a maximum altitude value is determined and input to the data structure cell that is represented by the two longitudinal geographic coordinates and two latitudinal geographic coordinates. Thus, data structure 500 holds values that represent maximum altitudes that may be traveled to via road for each geographical area that is represented by two longitudinal geographic coordinates and two latitudinal geographic coordinates. Data structures like data structure 500 may be generated from mapped geographic areas and road attribute data (e.g., road altitudes).

FIG. 6 shows how a data structure may be generated from a mapped geographical area. Mapped geographic area 600 includes a plurality of marks 605 representing different longitudinal coordinates and a plurality of marks 606 representing different latitudinal coordinates. Areas 610 that are bounded by longitudinal and lateral marks are areas of land and darker shades within these areas represent higher altitudes. Lighter shades represent lower altitudes. When generating a data structure to describe the area shown, each of the areas (e.g., 610) is represented via a cell in a data structure. Each cell in the data structure includes a value that indicates the elevation or altitude relative to sea level of a highest portion of a road selected from all roads that may be traveled and that lie within the geographical area represented by the data structure cell that is being referenced. The data structure that is stored in controller memory of the area shown includes values indicating maximum road elevation with the geographic area that is represented by the cell instead of a shade as shown.

In FIG. 6, a present geographic position of the hybrid vehicle is indicated via dot 602. The area that the hybrid vehicle may travel to from its present position and support travel on an ascending road with electric machine torque is represented via circle 604. The radius 609 of circle 602 represents distance away from the position of the hybrid vehicle that the vehicle may travel to and receive support from its electric machine to ascend a road. The radius may be a basis for adjusting the traction battery charge reserve amount.

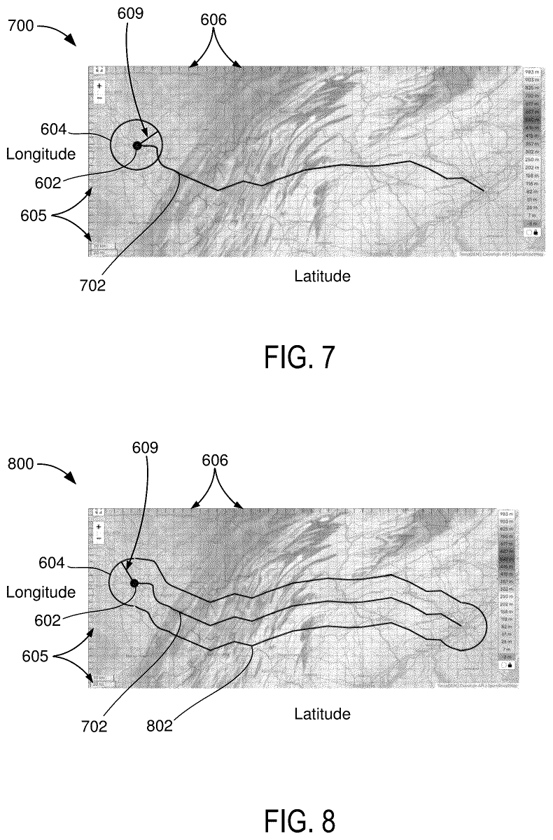

Referring now to FIG. 7, the mapped geographic area from FIG. 6 is reproduced and altered to include an example travel route 702 (e.g., road or roads leading to a destination). The areas, positions, and other elements of interest from FIG. 6 are recreated in FIG. 7. Additionally, FIG. 7 shows a travel route 702 that the area that is represented via circle 604 may follow so that the highest altitude within circle 604 that may be accessed via the vehicle by road may be periodically updated as the vehicle travels along the travel route 702. This may allow the traction battery charge reserve to be sufficient to assist ascending a road grade within the circle if the vehicle takes a detour from the scheduled travel route.

Referring now to FIG. 8, the mapped geographic area from FIGS. 6 and 7 is reproduced and altered to include the area that surrounds example travel route 702 that is used to determine a highest altitude that the hybrid vehicle may travel by road along the predetermined travel route 702. The areas, positions, and other elements of interest from FIGS. 6 and 7 are recreated in FIG. 8. FIG. 8 also shows the area 808 along travel route 702 that is considered for adjusting the traction battery charge reserve. Area 808 represents an area in which the highest altitude within circle 604 that may be accessed via the vehicle via a road is determined at different vehicle locations along travel route 702. This may allow the traction battery charge reserve to be sufficient to assist ascending a road grade within the area 808 if the vehicle takes a detour from the scheduled travel route.

Referring now to FIG. 9, a method for generating a data structure to determine a traction battery charge reserve amount and operate a vehicle according to the traction battery charge reserve amount is shown. The method of FIG. 9 may be incorporated into the system of FIGS. 1-3 as executable instructions stored in non-transitory memory. The method of FIG. 9 may be performed via one or more controllers. In some examples, at least some of the actions stated in method 900 may be performed via a human. The one or more controllers may receive inputs from one or more sensors described herein and adjust positions or operating states of one or more actuators described herein in the physical world.

At 902, method 900 judges whether or not a tow-haul mode is selected. Tow-haul mode may be selected via the human/machine interface. If method 900 judges that the tow-haul mode is activated, the answer is yes and method 900 proceeds to 904. Otherwise, the answer is no and method 900 proceeds to 950.

At 950, method 900 adjusts the traction battery reserve amount (e.g., the amount of charge or a percentage of total charge capacity of the traction battery that may be supplied to the electric machine when the chemically fueled power source is operating within a predetermined amount of maximum power of the chemically fueled power source at a present speed of the chemically fueled power source) to a predetermined baseline amount or percentage (e.g., 5% of the traction battery's actual total charge capacity). Method 900 may also adjust a traction battery charge depletion amount or percentage and a traction battery charge sustain amount or percentage. Method 900 proceeds to exit.

At 904, method 900 generates a data structure (e.g., an array of locations in controller memory) that may be referenced via longitudinal and latitudinal coordinates. Each cell or memory location within the data structure holds a value that represents a greatest altitude with respect to sea level that may be driven to via a road within the geographic area that is represented by the cell in the data structure (e.g., the geographic are that is bounded by two longitudinal coordinates and two latitudinal coordinates that are used to reference the data structure). Additionally, the road is the road within the geographic area that is used to reference the cell within the data structure that reaches a highest altitude within the geographic area that is used to reference the cell within the data structure. Thus, method 900 may select a road from a plurality of roads within the geographic area that is used to reference the cell that reaches a highest altitude of the roads within the geographic area that is used to reference the cell in the data structure. The data structure may include N rows by M columns of cells where N and M are integer real numbers. Method 900 proceeds to 906.

At 906, method 900 determines a distance radius (e.g., 609 of FIG. 6) that defines how far the vehicle may travel in any direction and may expect to have electric machine assistance to traverse an increasing grade of a road. The distance radius may be predetermined based on traction battery charge capacity, maximum vehicle load, maximum vehicle towing capacity, and a maximum expected road grade. In one example, method 900 may include a table or function of empirically determined values that are determined via operating the vehicle with maximum load and/or towing capacity. The table or function may be referenced via one or more of traction battery charge capacity, maximum vehicle load, maximum vehicle towing capacity, and maximum expected road grade. Additionally, in some examples, the distance radius may be dynamically adjusted according to present vehicle load and/or whether or not the vehicle is towing a load. Method 900 proceeds to 908 after the distance radius is determined.

At 908, method 900 determines the present geographical position of the vehicle. The present geographical position of the vehicle may be determined via a navigation system based on data from global positioning satellites. Method 900 proceeds to 910.

At 910, method 900 judges if the vehicle is being powered-on (e.g., activated) or if the vehicle has recently crossed a geographic location that is represented by geographic coordinates that define a boundary of a cell of the data structure. If so, the answer is yes and method 900 proceeds to 912. Otherwise, the answer is no and method 900 proceeds to exit.

At 912, method 900 references and queries the data structure of step 904 according to the vehicle's present geographical location to determine a maximum altitude that the vehicle may travel to within the vehicle's distance radius determined at step 906. The distance radius may extend through a distance that is greater than a distance that bounds one cell of the data structure. For example, the distance radius may be 25 kilometers and one cell of the data structure may include the highest altitude of a road that is with a 10 kilometer distance span between the geographical coordinates that reference the cell. Thus, the distance radius may span 2.5 cells within the data structure when the distance radius is orthogonal to the geographical coordinates that reference the cell of the data structure. Method 900 retrieves maximum altitude values for each cell that is within the distance radius extending from the vehicle's present geographical location as shown in FIG. 6. From this group of maximum values, method 900 selects the maximum of the values and proceeds to 914.

At 914, method 900 determines an altitude difference from the vehicle's present altitude to the value that represents the maximum of values that were retrieved from the data structure of step 904. Method 900 proceeds to 916.

At 916, method 900 determines a traction battery charge reserve according to the following equation:

$$Predictbateng = ( m \cdot g \cdot Δ h + Fdrag ( v ) \cdot \frac{dzone}{2} ) \cdot battratio + AF$$

where Predictbateng is the traction battery charge reserve amount, m is vehicle mass, g is earth gravitational constant, Δh is the altitude difference determined at 914, Fdrag is a function that returns a drag force for the vehicle, v is vehicle velocity, dzone is a distance to the vehicle travel zone boundary (e.g., the distance radius), battratio is a ratio of sustained maximum battery power to sustained maximum driver demand power, and AF is an adjustment factor or a battery charge reserve offset amount. Method 900 proceeds to 918.

At 918, method 900 adjusts operation of the chemically fueled power source and the electric machine according to the traction battery charge reserve amount. For example, based on the example SOC allocation shown by bar 350 of FIG. 3, method 900 may activate the internal combustion engine when the traction battery is depleted of 10-15% of SOC to sustain the traction battery SOC and to reduce a possibility of consuming a portion of the traction battery's charge reserve. However, if the vehicle is subject to driver demands that are beyond the internal combustion engine's capacity, method 900 may activate the electric machine to meet the higher driver demand. One example of activating the electric machine to meet driver demand may be during ascending a road. Method 900 proceeds to exit.

Thus, the method of FIG. 9 provides for adjusting a traction battery charge reserve amount or percentage according to a maximum altitude that a vehicle may reach by traveling a road that is within a predetermined distance of a vehicle's present geographical position. This may allow the vehicle's internal combustion engine to be assisted by an electric machine to meet driver demand while traversing roads that increase in altitude.

The method of FIG. 9 provides for a method for operating a vehicle, comprising: adjusting a vehicle battery charge reserve amount in response to a maximum altitude of a portion of a road within a predetermined distance of the vehicle, the road having a greatest altitude of a plurality of roads within the predetermined distance of the vehicle; and adjusting engine operation of the vehicle's chemically fueled power source and electric machine in response to the vehicle battery charge reserve amount. In a first example, the method includes where the plurality of roads are roads that stored in a database. In a second example that may include the first example, the method further comprises adjusting the vehicle battery charge reserve in further response to a mass of the vehicle. In a third example that may include one or both of the first and second examples, the method further comprises adjusting the vehicle battery charge reserve in further response to a mass of the vehicle. In a fourth example that may include one or more of the first through third examples, the method further comprises adjusting the vehicle battery charge reserve in further response to a speed of the vehicle. In a fifth example that may include one or more of the first through fourth examples, the method includes where adjusting a vehicle battery charge reserve amount includes raising the vehicle battery charge reserve amount in response to the road increasing in altitude. In a sixth example that may include one or more of the first through fifth examples, the method further comprises adjusting a vehicle battery charge sustain amount in response to attributes of the road.

The method of FIG. 9 also provides for a method for operating a vehicle, comprising: generating a value for a cell in a data structure according to a maximum altitude of a portion of a road that lies within a geographical area represented by the cell; storing the value in the cell in the data structure; and adjusting an electric energy storage device charge reserve amount according to the value. In a first example, the method further comprises adjusting operation of the vehicle according to the value, where adjusting operation of the vehicle includes activating and deactivating an internal combustion engine. In a second example that may include the first example, the method includes where the geographical area is identified via longitudinal and latitudinal coordinates. In a third example that may include one or both of the first and second examples, the method includes where the data structure is stored in memory of a controller. In a fourth example that may include one or more of the first through third examples, the method includes where the electric energy storage device charge reserve amount is a portion of a battery's total charge storage capacity.

Note that the example control and estimation routines included herein can be used with various engine and/or vehicle system configurations. The control methods and routines disclosed herein may be stored as executable instructions in non-transitory memory and may be carried out by the control system including the controller in combination with the various sensors, actuators, and other engine hardware. The specific routines described herein may represent one or more of any number of processing strategies such as event-driven, interrupt-driven, multi-tasking, multi-threading, and the like. As such, various actions, operations, and/or functions illustrated may be performed in the sequence illustrated, in parallel, or in some cases omitted. Likewise, the order of processing is not necessarily required to achieve the features and advantages of the example embodiments described herein, but is provided for ease of illustration and description. One or more of the illustrated actions, operations and/or functions may be repeatedly performed depending on the particular strategy being used. Further, at least a portion of the described actions, operations and/or functions may graphically represent code to be programmed into non-transitory memory of the computer readable storage medium in the control system. The control actions may also transform the operating state of one or more sensors or actuators in the physical world when the described actions are carried out by executing the instructions in a system including the various engine hardware components in combination with one or more controllers.

This concludes the description. The reading of it by those skilled in the art would bring to mind many alterations and modifications without departing from the spirit and the scope of the description. For example, I3, I4, I5, V6, V8, V10, and V12 engines operating in natural gas, gasoline, diesel, or alternative fuel configurations could use the present description to advantage.

1. A method for operating a vehicle, comprising:
adjusting a vehicle battery charge reserve amount in response to a maximum altitude of a portion of a road within a predetermined distance of the vehicle, the road having a greatest altitude of a plurality of roads within the predetermined distance of the vehicle; and
adjusting operation of a chemically fueled power source and electric machine in response to the vehicle battery charge reserve amount.

2. The method of claim 1, where the plurality of roads are roads that are stored in a database.

3. The method of claim 1, further comprising adjusting the vehicle battery charge reserve amount in further response to a mass of the vehicle.

4. The method of claim 3, further comprising adjusting the vehicle battery charge reserve amount in further response to the mass of the vehicle.

5. The method of claim 4, further comprising adjusting the vehicle battery charge reserve amount in further response to a speed of the vehicle.

6. The method of claim 1, where adjusting the vehicle battery charge reserve amount includes raising the vehicle battery charge reserve amount in response to the road increasing in altitude.

7. The method of claim 1, further comprising adjusting a vehicle battery charge sustain amount in response to attributes of the road.

8. A vehicle, comprising:
a chemically fueled power source;
an electric machine;
a traction battery;
a human/machine interface; and
a controller including executable instructions stored in non-transitory memory that cause the controller to reference a data structure containing altitude values according to a present geographical location of the vehicle and a predetermined distance, adjust a reserve amount of the traction battery in response to an altitude, and operate the chemically fueled power source and the electric machine according to the reserve amount.

9. The vehicle of claim 8, where the data structure is segmented into a plurality of cells, and where the plurality of cells are referenced according to longitude coordinates and latitude coordinates.

10. The vehicle of claim 8, further comprising a vehicle navigation system that communicates the present geographical location to the controller.

11. The vehicle of claim 8, where the reserve amount of power is an amount of power that may be supplied to the electric machine when the chemically fueled power source is operating within a predetermined amount of maximum power of the chemically fueled power source at a present speed of the chemically fueled power source.

12. The vehicle of claim 8, further comprising additional executable instructions stored in non-transitory memory that cause the controller to retrieve the altitude from the data structure.

13. The vehicle of claim 8, where operating the chemically fueled power source and the electric machine according to the reserve amount includes activating the chemically fueled power source to maintain the reserve amount.

14. The vehicle of claim 8, where the reserve amount is adjusted in further response to a mass of the vehicle.

15. The vehicle of claim 8, where the reserve amount is adjusted in further response to a distance to a zone boundary.

16. A method for operating a vehicle, comprising:
generating a value for a cell in a data structure according to a maximum altitude of a portion of a road that lies within a geographical area represented by the cell;
storing the value in the cell in the data structure; and
adjusting an electric energy storage device charge reserve amount according to the value.

17. The method of claim 16, further comprising adjusting operation of the vehicle according to the value, where adjusting operation of the vehicle includes activating and deactivating an internal combustion engine.

18. The method of claim 17, where the geographical area is identified via longitudinal and latitudinal coordinates.

19. The method of claim 16, where the data structure is stored in memory of a controller.

20. The method of claim 16, where the electric energy storage device charge reserve amount is a portion of a battery's total charge storage capacity.
